(19) United States
(12) Patent Application Publication
(10) Pub. No.: US 2025/0117172 A1
(43) Pub. Date: Apr. 10, 2025

(54) COMPUTER-READABLE MEDIUM AND CONTROL METHOD

(71) Applicant: CANON KABUSHIKI KAISHA, Tokyo (JP)

(72) Inventor: TAKESHI HAYAKAWA, Kanagawa (JP)

(21) Appl. No.: 18/903,086

(22) Filed: Oct. 1, 2024

(30) Foreign Application Priority Data
Oct. 5, 2023 (JP) 2023-173861

(51) Int. Cl. G06F 3/12; H04N 1/00

(52) U.S. Cl. CPC G06F 3/1261; G06F 3/1203; H04N 1/00938

(57) ABSTRACT

A method of controlling a first apparatus and a second apparatus is provided. The first apparatus has a first operating environment that is on a host OS, but is not on a guest OS, and the second apparatus has a second operating environment that is on the guest OS. In the first apparatus, a program accepts a selection of any from discovered printers, and when the selected printer is a printer not supported by the program, performs processing related to an other program different from the program. In the second apparatus, the program accepts a selection of any from discovered printers, and when the selected printer is a printer not supported by the program, performs processing related to a printing program standard in the host OS, the printing program being different from the program and the other program.

### BACKGROUND OF THE INVENTION

### Field of the Invention

The present invention relates to a computer-readable medium and a control method.

### Description of the Related Art

Japanese Patent No. 6127610 describes a terminal apparatus which, when a given application is executed and a list of other applications linked from that given application is displayed, determines whether the linked applications are trustworthy and hides those applications that are not. Here, whether an application is trustworthy is determined based on an application-specific ID, a device host name, and the like registered in a whitelist in advance.

According to Japanese Patent No. 6127610, another application linked from a given application is identified based on whether that other application is registered in the whitelist. In other words, the actual trustworthiness, i.e., whether the linked application operates normally in that operating environment, is not used as the basis of the determination.

However, according to Japanese Patent No. 6127610, even if the linked application is obtained and operated, the linked application may not operate as expected due to the operating environment. The terminal apparatus described in Japanese Patent No. 6127610 cannot handle such a situation.

### SUMMARY OF THE INVENTION

The present invention provides a program, capable of handling a plurality of operating environments, which controls the execution of an appropriate program in accordance with the operating environment.

One aspect of the present invention provides a non-transitory computer-readable medium having stored a predetermined program operatable on an operating system (OS), which when executed by one or more processors of a first information processing apparatus having a first operating environment on a first OS operating as a host OS but not on a guest OS, cause the first information processing apparatus to perform a first method, the first method comprising: displaying one or more printers discovered through a search performed by the first information processing apparatus; accepting a selection of any printer among the one or more printers; and when the printer selected from the one or more printers is a printer not supported by the predetermined program, performing processing related to an other program different from the predetermined program, and wherein the predetermined program, which when executed by one or more processors of a second information processing apparatus having a second operating environment on a second OS operating as the host OS and on the guest OS, cause the second information processing apparatus to perform a second method, the second method comprising: displaying one or more printers discovered through a search performed by the second information processing apparatus; accepting a selection of any printer among the one or more printers; and when the printer selected from the one or more printers is a printer not supported by the predetermined program, performing processing related to a printing program standard in the host OS, the printing program being different from the predetermined program and the other program.

This configuration make it possible to provide a program, capable of handling a plurality of operating environments, which controls the execution of an appropriate program in accordance with the operating environment.

Further features of the present invention will become apparent from the following description of exemplary embodiments with reference to the attached drawings.

### BRIEF DESCRIPTION OF THE DRAWINGS

FIG. 1 is a diagram illustrating an example of the configuration of a communication system.

FIG. 2 is a diagram illustrating a wireless connection sequence performed in WFD mode.

FIGS. 3A and 3B are diagrams illustrating the software configuration of an information processing apparatus.

FIG. 4 is a diagram illustrating the software configuration of a printing app.

FIG. 5 is a flowchart illustrating an example of a printer search processing sequence.

FIG. 6 is a diagram illustrating an example of a printer registration screen.

FIG. 7 is a flowchart illustrating an example of a printer registration processing sequence.

FIGS. 8A, 8B, and 8C are diagrams illustrating examples of messages displayed when registering a printer.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

It is also to be understood that changes and improvements made to the embodiment described below based on the ordinary knowledge of one skilled in the art and which do not depart from the essential spirit of the present invention also fall within the scope of the present invention.

### First Embodiment

An information processing apparatus and a communication apparatus included in a communication system according to the present embodiment will be described hereinafter. The present embodiment will describe a smartphone as an example of the information processing apparatus, but the information processing apparatus is not limited thereto, and any of a variety of devices, such as a mobile terminal, a laptop PC, a tablet terminal, a Personal Digital Assistant (PDA), a digital camera, or the like, may be applied thereto. Likewise, any of a variety of devices can be applied as the communication apparatus, as long as the device is capable of communicating with the information processing apparatus wirelessly. For example, if the device is a printer, the printer may be an ink jet printer, an electrophotographic printer, or the like. However, the device is not limited to a printer, and can be applied in a scanner, a copier, a facsimile device, a mobile terminal, a smartphone, a laptop PC, a tablet terminal, a PDA, a digital camera, a music playback device, a television, a smart speaker, or the like as well. The device can also be a multifunction peripheral provided with a plurality of functions, such as a copying function, a fax function, a printing function, a scanner function, and the like. The present embodiment will assume that the communication apparatus is a multifunction printer having a printing function, a scanner function, and the like.

### Hardware Configurations of Apparatuses

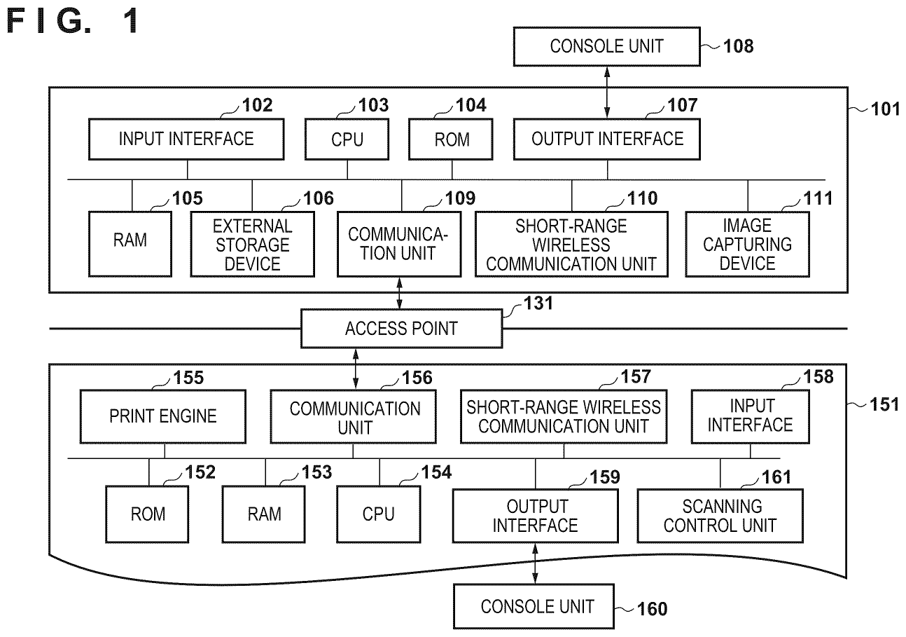

First, the configuration of the information processing apparatus included in the communication system of the present embodiment, and the configuration of a communication apparatus capable of communicating with the information processing apparatus, will be described with reference to the block diagram in FIG. 1. Although the present embodiment will describe an example having the following configuration, the functions are not intended to be limited particularly to the content of FIG. 1.

An information processing apparatus 101 includes an input interface 102, a CPU 103, a ROM 104, a RAM 105, an external storage device 106, an output interface 107, a console unit 108, a communication unit 109, a short-range wireless communication unit 110, and an image capturing device 111.

The input interface 102 is an interface for receiving data inputs, operational instructions, and the like from a user, and is constituted by a physical keyboard, buttons, a touch panel, or the like. Note that the output interface 107 (described later) and the input interface 102 may be implemented by the same configuration, with that configuration both outputting screens and accepting operations from the user.

The CPU 103 is a system control unit, and controls the information processing apparatus 101 as a whole.

The ROM 104 stores fixed data such as control programs executed by the CPU 103, data tables, an embedded operating system (“OS”, hereinafter) program, and the like. In the present embodiment, the control programs stored in the ROM 104 perform software execution control, such as scheduling, task switching, interrupt processing, and the like, under the management of the embedded OS stored in the ROM 104. Note that the present embodiment assumes that the OS stored in the ROM 104 and operated on the information processing apparatus 101 is the Android (registered trademark) OS or the Chrome (registered trademark) OS, both of which are provided by Google. If the OS operating on the information processing apparatus 101 is the Chrome OS, the ROM 104 is assumed to also store a virtual Android OS for executing Android OS apps (described later) on the information processing apparatus 101.

The RAM 105 is constituted by Static Random Access Memory (SRAM) or the like that requires a backup power source. Note that the RAM 105 holds data in a primary battery for data backup (not shown), and can therefore store important data such as program control variables in a non-volatile state. A memory area for storing setting information of the information processing apparatus 101, management data of the information processing apparatus 101, and the like is also provided in the RAM 105. The RAM 105 is used as a main memory and a working memory for the CPU 103.

The external storage device 106 includes an application program having a function for communicating with a communication apparatus 151. This application program is also referred to as a “communication app” hereinafter. Specifically, the communication app is an app having a printing function for causing the communication apparatus 151 to print, a scan function for causing the communication apparatus 151 to scan, and the like. The communication app is not limited thereto, however, and may be an app having only a printing function or a scan function, or may be an app having other functions. Additionally, the external storage device 106 includes various types of programs, such as a print information generation program that generates print information which can be interpreted by the communication apparatus 151, an information sending/receiving control program that sends and receives information to and from the connected communication apparatus 151 through the communication unit 109, and the like. The external storage device 106 stores various types of information used by these programs. The device also stores image data obtained from other information processing apparatuses or the Internet through the communication unit. The present embodiment assumes that the communication app is an application for Android OS (also referred to as an Android OS app).

The output interface 107 is an interface for controlling the console unit 108 to display data, make notifications of the state of the information processing apparatus 101, and the like.

The console unit 108 is constituted by light-emitting diodes (LEDs), a liquid crystal display (LCD), or the like, and displays data, makes notifications regarding the state of the information processing apparatus 101, and the like. Note that inputs from the user can be received through the console unit 108 by providing, in the console unit 108, a software keyboard including numerical value input keys, a mode setting key, a confirm key, a cancel key, a power key, and the like.

The communication unit 109 is connected to devices such as the communication apparatus 151, and is configured to communicate data. For example, the communication unit 109 is capable of connecting to an access point (not shown) in the communication apparatus 151. Connecting the communication unit 109 and the access point in the communication apparatus 151 enables the information processing apparatus 101 and the communication apparatus 151 to communicate with each other. The access point may be referred to as an “AP” hereinafter. Note that the communication unit 109 may communicate directly with the communication apparatus 151 wirelessly, or may communicate through an access point 131 outside the information processing apparatus 101 and the communication apparatus 151. The present embodiment assumes that the IEEE 802.11 series communication standard is used as the wireless communication method. The IEEE 802.11 series communication standard is Wi-Fi (registered trademark).

A device such as a wireless LAN router or the like can be given as an example of the access point 131. Note that a method in which the information processing apparatus 101 and the communication apparatus 151 connect directly without using an external access point will be referred to as a “direct connection method” in the present embodiment. A method in which the information processing apparatus 101 and the communication apparatus 151 connect via the external access point 131 will be referred to as an infrastructure connection method hereinafter.

The short-range wireless communication unit 110 is a configuration for wirelessly connecting to devices at a short distance, such as the communication apparatus 151, and communicating data, and communicates using a communication method different from that of the communication unit 109. The short-range wireless communication method used by the short-range wireless communication unit 110 is, for example, Bluetooth (registered trademark), Near-Field Communication (NFC), or the like. The type of Bluetooth may be Bluetooth Classic or Bluetooth Low Energy. The short-range wireless communication unit 110 can connect to a short-range wireless communication unit 157 in the communication apparatus 151.

The image capturing device 111 is a device that converts images captured by an image capturing element into digital data. The digital data is initially stored in the RAM 105. The digital data is then converted to a predetermined image format by a program executed by the CPU 103, and the resulting data is stored in the external storage device 106 as image data.

The communication apparatus 151 includes a ROM 152, a RAM 153, a CPU 154, a print engine 155, a communication unit 156, the short-range wireless communication unit 157, an input interface 158, an output interface 159, a console unit 160, a scanning control unit 161, and the like. When a connection mode (a communication mode) is set, the communication apparatus 151 can operate in the set connection mode.

The communication unit 156 is a configuration for the communication apparatus 151 to communicate with other devices, and in the present embodiment, the communication unit 156 communicates according to the IEEE 802.11 series communication standard. The communication unit 156 has an access point for connecting to devices such as the information processing apparatus 101 as an access point within the communication apparatus 151. The access point can connect to the communication unit 109 of the information processing apparatus 101. Note that the communication unit 156 may communicate directly with the information processing apparatus 101 wirelessly, or may communicate via the access point 131. Additionally, the communication unit 156 may include hardware that functions as an access point, or may operate as an access point using software for functioning as an access point. The present embodiment assumes that the communication unit 156 and the short-range wireless communication unit 157 are implemented as a single wireless chip. In other words, in the present embodiment, a combo chip is assumed to be used, which handles both an IEEE 802.11 series communication standard communication function and a short-range wireless communication-based communication function. However, the configuration is not limited thereto, and the communication unit 156 and the short-range wireless communication unit 157 may be implemented by separate wireless chips.

The RAM 153 is constituted by DRAM or the like or the like that requires a backup power source. Note that the RAM 153 holds data by being supplied with power for data backup (not shown), and can therefore store important data such as program control variables in a non-volatile state. The RAM 153 is also used as a main memory and working memory for the CPU 154, and includes a reception buffer for temporarily storing print information received from the information processing apparatus 101 or the like, stores various types of information, and the like.

The ROM 152 stores fixed data such as control programs executed by the CPU 154, data tables, OS programs, and the like. In the present embodiment, the control programs stored in the ROM 152 perform software execution control, such as scheduling, task switching, interrupt processing, and the like, under the management of the embedded OS stored in the ROM 152. A memory area for storing data required to be held even when power is not supplied, such as setting information of the communication apparatus 151, management data of the communication apparatus 151, and the like, is also provided in the ROM 152.

The CPU 154 is a system control unit, and controls the communication apparatus 151 as a whole.

Based on the information stored in the RAM 153 and a print job received from the information processing apparatus 101 or the like, the print engine 155 forms an image on a recording medium such as paper using a recording agent such as ink, and the result of the printing is output. At this time, the print job sent from the information processing apparatus 101 or the like involves sending a large amount of data and requires high-speed communication, and is therefore received via the communication unit 156, which is capable of faster communication than the short-range wireless communication unit 157.

The short-range wireless communication unit 157 is a configuration for wirelessly connecting to devices at a short distance, such as the information processing apparatus 101, and communicating data, and communicates using a communication method different from that of the communication unit 156. The short-range wireless communication method used by the short-range wireless communication unit 157 is, for example, Bluetooth (registered trademark), NFC, or the like. The type of Bluetooth may be Bluetooth Classic or Bluetooth Low Energy. The short-range wireless communication unit 157 can connect to the short-range wireless communication unit 110.

The input interface 158 is an interface for receiving data inputs, operational instructions, and the like from a user, and is constituted by a physical keyboard, buttons, a touch panel, or the like. Note that the output interface 159 (described later) and the input interface 158 may be implemented by the same configuration, with that configuration both outputting screens and accepting operations from the user. The output interface 159 is an interface for controlling the console unit 160 to display data, make notifications of the state of the communication apparatus 151, and the like.

The console unit 160 is constituted by a display unit such as light-emitting diodes (LEDs), a liquid crystal display (LCD), or the like, and displays data, makes notifications regarding the state of the communication apparatus 151, and the like. Note that inputs from the user can be received through the console unit 160 by providing, in the console unit 160, a software keyboard including numerical value input keys, a mode setting key, a confirm key, a cancel key, a power key, and the like.

The scanning control unit 161 includes an image sensor unit (a reading unit) that scans a document placed on a document platform or an ADF (not shown). The image sensor unit includes a light source that irradiates the document with light, and an image sensor in which elements that read light reflected by the document and photoelectrically convert that light are arranged. The scanning control unit 161 obtains image data by analog-digital (AD) conversion of an analog electrical signal obtained by the image sensor unit reading the document. The scanning control unit 161 also includes circuitry for direct memory access (DMA) transfer to store the obtained image data in the RAM 153.

### Direct Connection Method

“Direct connection” refers to a form in which devices connect directly to each other (i.e., peer-to-peer) wirelessly, without going through an external device such as the access point 131. The communication apparatus 151 can operate in a mode for communicating over a direct connection (a “direct connection mode”) as one connection mode. Wi-Fi communication includes a plurality of modes for communicating over a direct connection, such as software AP mode, Wi-Fi Direct (registered trademark) mode, and the like. Wi-Fi Direct will be referred to as “WFD” hereinafter.

A mode in which a direct connection is made through WFD is called “WFD mode”. WFD is a standard developed by the Wi-Fi Alliance and is included in the IEEE 802.11 series communication standard. In WFD mode, a device to serve as a communication partner is searched for using device search information, after which the roles of P2P group owner (GO) and P2P client are determined, and the remaining wireless connections are processed. “Group owner” corresponds to the parent station (parent device) in Wi-Fi, and the client corresponds to a child station (child device) in Wi-Fi. This role determination corresponds to GO Negotiation in P2P, for example. In WFD mode, the communication apparatus 151 is neither the parent station nor the child station before the roles have been determined. Specifically, one device among the devices that are to communicate issues the device search information, and searches for a device to connect to in WFD mode. When the other device, which is to serve as the communication partner, is discovered, the devices confirm information on the services and functions those respective devices can supply. Note that the confirmation of the device supply information is optional, and is not required. The device supply information confirmation phase corresponds to Provision Discovery in P2P, for example. Next, which device will serve as the P2P client and which will serve as the P2P group owner is determined by confirming this device supply information with each other. Once the client and the group owner have been determined, the devices exchange parameters for communicating through WFD. The remaining wireless connections and IP connections are processed between the P2P client and group owner based on the exchanged parameters. Note that in WFD mode, the GO Negotiation described above may be skipped, and the communication apparatus 151 may always operate as the GO. In other words, the communication apparatus 151 may operate in Autonomous GO mode, which is a WFD mode. A state in which the communication apparatus 151 is operating in WFD mode is a state in which, for example, a connection using WFD is not established but the communication apparatus 151 is operating as the GO, a connection using WFD is established and the communication apparatus 151 is operating as the GO, or the like.

In the software AP mode, among the communicating devices (e.g., the information processing apparatus 101 and the communication apparatus 151), one of the devices (e.g., the information processing apparatus 101) functions as a client that has a role of requesting various types of services. The other device provides a Wi-Fi access point function through software settings. The software AP corresponds to the parent station in Wi-Fi, and the client corresponds to the child station in Wi-Fi. In software AP mode, the client uses the device search information to search for a device that will serve as a software AP. Once a software AP is discovered, the remaining wireless connection processing (the establishment of a wireless connection and the like) is performed between the client and the software AP, after which IP connection processing (IP address allocation and the like) is performed. Note that commands, parameters, and the like sent and received when establishing a wireless connection between the client and the software AP may be any specified by the Wi-Fi standard, and will therefore not be described here.

In the present embodiment, when establishing and maintaining a direct connection, the communication apparatus 151 operates as the parent station in the network to which the communication apparatus 151 belongs. Note that “parent station” refers to a device that constructs a wireless network, and is a device that provides child stations with the parameters used to connect to the wireless network. The parameters used to connect to the wireless network are parameters pertaining to a channel used by the parent station, for example. By receiving these parameters, a child station connects to the wireless network constructed by the parent station using the channel used by the parent station. In direct connection mode, the communication apparatus 151 operates as the parent station, and the communication apparatus 151 can therefore determine which frequency band and which channel to use in the communication performed in direct connection mode. In the present embodiment, the communication apparatus 151 is assumed to use a channel corresponding to the 2.4 GHz frequency band and a channel corresponding to the 5 GHz frequency band in the communication performed in direct connection mode. The user can then set the frequency band to be used (i.e., the frequency band channel to be used) as desired by making a setting in the screen displayed by the communication apparatus 151. However, the present embodiment assumes that even if 5 GHz is selected in the screen displayed by the communication apparatus 151, the communication apparatus 151 will not use a channel corresponding to a Dynamic Frequency Selection (DFS) band in the 5 GHz frequency band for the communication performed in direct connection mode. In other words, the communication apparatus 151 is assumed to use only channels corresponding to frequency bands outside the DFS band in the 5 GHz frequency band for the communication performed in direct connection mode. If, when using a channel corresponding to the DFS band, a radar wave is detected in the frequency band corresponding to that channel, it is necessary to change the channel currently being used. A frequency band in which the channel may be changed in response to a radar wave being detected is called a “DFS band”. Note, however, that it may be possible to use a channel corresponding to the DFS band among the 5 GHz frequency band for communication performed in direct connection mode when, for example, using a wireless chip that supports the DFS function.

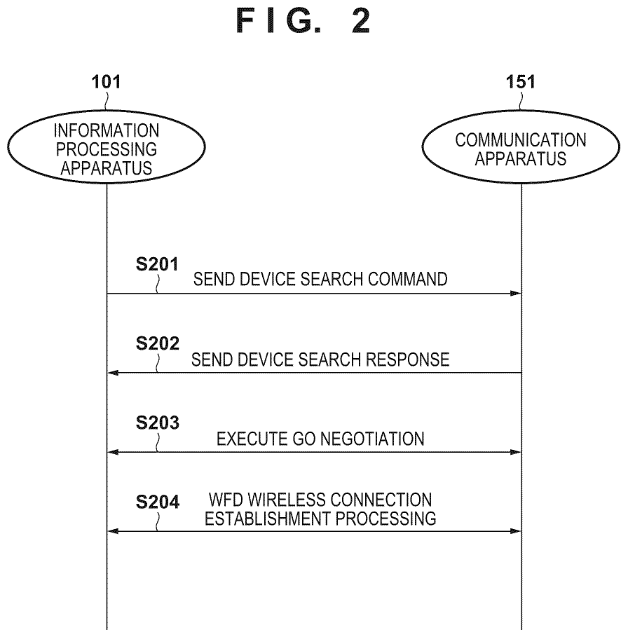

FIG. 2 is a diagram illustrating a wireless connection sequence performed in WFD mode. Processing executed by each device in this sequence is implemented by the CPU of each device reading out various programs stored in a memory provided in that device, such as the ROM or the like, into the RAM and executing those programs. Additionally, this processing is assumed to be started when a predetermined operation for establishing a connection through WFD is received from the user in a state where a predetermined application for executing a WFD function is operating on each device. Note that the “predetermined operation for establishing a connection through WFD” is an operation for selecting an “enable/disable direct connection mode” button, for example. The operation corresponds to an operation for starting direct connection mode.

First, in step S201, the information processing apparatus 101 sends the device search information and searches for a device that supports the WFD function as a communication partner device.

Next, in step S202, if the received device search information is information sent using the same channel as the channel currently used for direct connection mode, the communication apparatus 151 sends a device search response, which is a response to the stated information, to the information processing apparatus 101. The information processing apparatus 101 discovers the communication apparatus 151 as a device that supports the WFD function as a result. Note that after the information processing apparatus 101 discovers the communication apparatus 151, processing for exchanging information regarding the services, functions, and the like each apparatus can supply may be performed between the two apparatuses.

Next, in step S203, GO Negotiation is performed between the information processing apparatus 101 and the communication apparatus 151. Once the client and the group owner have been determined, the apparatuses exchange parameters for communicating through WFD. The remaining wireless connections and IP connections are processed between the P2P client and group owner based on the exchanged parameters. As described above, the GO Negotiation may be skipped and the communication apparatus 151 may always operate the as the GO by having the communication apparatus 151 operate in Autonomous GO mode. Additionally, when the communication apparatus 151 operates as the GO, the communication apparatus 151 acts as the parent station and determines the frequency band and channel to use in the WFD communication. As such, the communication apparatus 151 operating as the GO can select whether to use the 5 GHz or the 2.4 GHz frequency band, and can select which of the channels corresponding to the determined frequency band is to be used.

Then, in step S204, each apparatus executes WFD wireless connection establishment processing based on the exchange parameters and using the channel determined by the GO.

### Infrastructure Connection Method

“Infrastructure connection” is a type of connection for devices which are to communicate (e.g., the information processing apparatus 101 and the communication apparatus 151) to connect to an access point overseeing the network of those devices (e.g., the access point 131) and communicate with each other via the access point. The communication apparatus 151 is also capable of operating in a mode for communicating over an infrastructure connection (infrastructure connection mode) as one connection mode.

In an infrastructure connection, each device uses device search information to search for an access point. Once an access point is discovered, the remaining wireless connection processing (the establishment of a wireless connection and the like) is performed between the devices and the access point, after which IP connection processing (IP address allocation and the like) is performed. Note that commands, parameters, and the like sent and received when establishing a wireless connection between the devices and the access point may be any specified by the Wi-Fi standard, and will therefore not be described here.

In the present embodiment, when the communication apparatus 151 operates in infrastructure connection mode, the access point 131 operates as the parent station, and the communication apparatus 151 operates as a child device. In other words, in the present embodiment, “infrastructure connection” refers to a connection between the communication apparatus 151, which operates as a child device, and a device operating as a parent device. When the communication apparatus 151 has established an infrastructure connection and the information processing apparatus 101 has also established an infrastructure connection with the access point 131, the communication apparatus 151 and the information processing apparatus 101 can communicate via the access point 131. The channel used for communication in the infrastructure connection is determined by the access point 131, and thus the communication apparatus 151 communicates in the infrastructure connection using the channel determined by the access point 131.

In the present embodiment, the communication apparatus 151 is assumed to use a channel corresponding to the 2.4 GHz frequency band and a channel corresponding to the 5 GHz frequency band in the communication performed in the infrastructure connection. Note that the communication apparatus 151 can also use a channel corresponding to the DFS band and the 5 GHz frequency band in the communication performed in the infrastructure connection. Note also that to communicate with the communication apparatus 151 via the access point 131, it is necessary for the information processing apparatus 101 to recognize that the communication apparatus 151 belongs to the network formed by the access point 131 and to which the information processing apparatus 101 belongs.

Additionally, when the information processing apparatus 101 and the communication apparatus 151 are connected to the access point 131 by an infrastructure connection, the communication apparatus 151 can be discovered through a broadcast made by the information processing apparatus 101.

### Software Configuration of Information Processing Apparatus 101

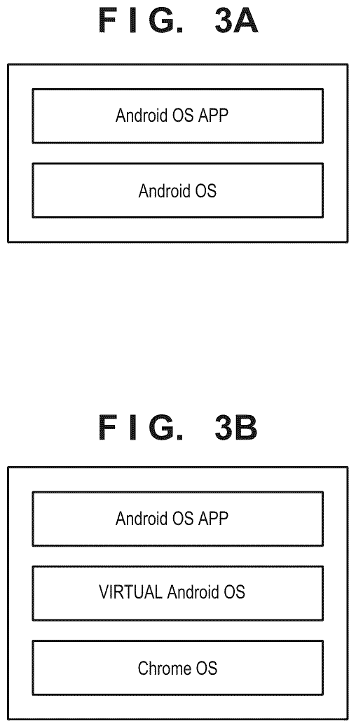

The software configuration of the information processing apparatus 101 according to the present embodiment will be described next. FIG. 3A illustrates an example of the software configuration of the information processing apparatus 101 when the host OS operating on the information processing apparatus 101 is the Android OS. In this configuration, Android OS apps operate on the Android OS. Here, it is assumed that the software configuration of the information processing apparatus 101 does not include the Chrome OS. An environment in which the OS operating on the lowest layer of the information processing apparatus 101 is the Android OS (i.e., is not the Chrome OS), as in this case, will be called a “first environment” hereinafter. The first environment is also referred to as a “first operating environment” or “real environment”. Specifically, the first environment is an environment in which, for example, the information processing apparatus 101 is provided with a host OS but not with a guest OS, and the communication app operates on the host OS. Additionally, the first environment is, for example, an environment in which the information processing apparatus 101 is provided with both a host OS and a guest OS, but the communication app operates on the host OS but operates without going through the guest OS (does not operate on the guest OS). Note that “host OS” is an abbreviation for “host operating system”, and “guest OS” is an abbreviation for “guest operating system”.

FIG. 3B illustrates an example of the software configuration of the information processing apparatus 101 when the host OS operating on the information processing apparatus 101 is the Chrome OS. In this configuration, a virtual Android OS, which is a virtual OS, operates on the Chrome OS. Android OS apps operate on the virtual Android OS. An environment in which the OS operating on the lowest layer of the information processing apparatus 101 is the Chrome OS and a virtual Android OS is operating on the Chrome OS, as in this case, will be called a “second environment” hereinafter. The second environment is also referred to as a “second operating environment” or “real environment”. Note that in the present embodiment, the “virtual OS” is a program for operating apps not supported by the host OS on the host OS, and is a guest OS. The virtual OS may be an entire existing OS, such as the Android OS or the like, an OS obtained by omitting some modules from an entire existing OS, or a program created separately from an existing OS. The virtual OS is implemented through virtualization techniques such as a Virtual Machine, a container-based technique, or the like.

The virtual Android OS may be implemented by an emulator the delegates function such as resource management and the like to the Chrome OS and provides an execution environment for Android apps. In this case, the emulator itself is not the OS, but provides the virtual Android OS, including the Chrome OS, i.e., the second environment.

Issues that arise when an Android OS app is operate in the second environment will be described hereinafter. An example in which the aforementioned communication app is installed and operate in both the first environment and the second environment will be described here. Because the communication app has a function for communicating with the communication apparatus 151, which has a printing function, and printing images and the like, the communication app may also be called a “printing app”. Additionally, application programs developed for the Android OS so as to be operate on the Android OS may be referred to as “Android apps”.

The communication app of the present embodiment, which is an Android app, provides a function for printing images (called “photo printing” hereinafter), and when the photo printing function is selected, displays, in an image list screen, icons indicating image data stored in a predetermined folder. Image data selected therefrom can be sent to the communication apparatus 151 and printed.

### First Issue

The issue focused on in the present embodiment is that another application (to be abbreviated as “app” hereinafter) may be launched from an Android OS app that is currently operating, in which case the other app that has been launched may not necessarily operate correctly in the second environment. It is necessary for an Android OS app operate in the second environment to be operated in the same manner in the second environment as in the first environment. As such, an app intended to be used in the second environment is typically distributed after the operations of that app have been confirmed by the app vendor. However, even when an app whose operations are guaranteed is operating in the second environment, if another app is launched from the stated app, it is not necessarily the case that the other app will operate correctly in the second environment.

More specifically, when printing an image using the communication app, the selected image is printed using the communication apparatus (also called a “printing apparatus” or “printer” hereinafter) 151, which has already been registered, or using a printer which has been searched for from the network. At this time, the printer to be used may be a model which is not supported by the communication app. In this case, if another app that supports the printer which has been searched for is already installed, the communication app launches the other app and continues the printing from the other app. If such an app is not already installed, the user is prompted to install the app. In this case, if the other app is an app that supports the first environment and which uses the first environment as the execution environment, there is no problem. However, if the other app is an app not guaranteed to operate in the second environment and which uses the second environment as the execution environment, it is possible that even if the other app is launched, the other app will operate differently from the operations in the first environment, such as operating in an unexpected manner, crashing, or the like while operating.

The present embodiment addresses such an issue by using the configurations and methods described hereinafter to prevent or suppress situations in which the issue described above arises. Note that other issues may arise in the second environment, as will be described hereinafter.

### Second Issue

A method called “broadcast search” is known as a method for searching for devices with which the information processing apparatus 101 can communicate using the communication app. “Broadcast search” is a method in which devices are discovered by sending broadcast search packets and receiving responses. Specifically, in a broadcast search, the communication app first launches a Socket Application Programming Interface (socket API). Through this, the communication app instructs the OS of the information processing apparatus 101 to send a broadcast search packet. The OS then sends a broadcast search packet to the access point (here, the access point 131) that forms the network to which the information processing apparatus 101 belongs (is connected). The broadcast search packet is a packet in which a broadcast search value is set in the IP address storage region, and a value indicating that the destination of the packet is unspecified is set. In the present embodiment, the content of the broadcast search packet is specified by the communication app. In other words, a device that can interpret the content of the broadcast search packet is a device supported by the communication app. Specifically, the device supported by the communication app is, for example, a printing apparatus provided by the vendor of the communication app. In the present embodiment, the communication apparatus 151 is assumed to be a device supported by the communication app. Having received the broadcast search packet, the access point 131 sends that packet to all the devices belonging to the network formed by the access point 131. When a device capable of interpreting the packet receives the packet, the device sends a response to the information processing apparatus 101, which is the origin of the packet, via the access point 131. The OS of the information processing apparatus 101 receives the response and sends the received response to the communication app. Through this, the information processing apparatus 101 can discover each device that sent a response through the communication app, and can execute processing based on the result of the broadcast search. Specifically, the “processing based on the result of the search” is, for example, processing for displaying a result of the search, processing for communicating with the devices discovered through the search, or the like.

Meanwhile, a method called “multicast search” is also known as a method for searching for devices with which the information processing apparatus 101 can communicate using the communication app. “Multicast search” is a method in which devices are discovered by sending multicast search packets and receiving responses. Specifically, in a multicast search, the communication app first instructs the OS of the information processing apparatus 101 to send a multicast search packet by executing the socket API. The OS then sends a multicast search packet to the access point (here, the access point 131) that forms the network to which the information processing apparatus 101 belongs (is connected). The multicast search packet is a packet in which a multicast search value is set in the IP address storage region, and a value indicating that a specific type of device is specified as the destination of the packet is set. In the present embodiment, the content of the multicast search packet is specified by the communication app. In other words, a device that can interpret the content of the multicast search packet is a device supported by the communication app. Having received the multicast search packet, the access point 131 sends that packet to the devices, among all the devices belonging to the network formed by the access point 131, that are of the type specified by the multicast search packet. When a device capable of interpreting the packet receives the packet, the device sends a response to the information processing apparatus 101, which is the origin of the packet, via the access point 131. The OS of the information processing apparatus 101 receives the response and sends the received response to the communication app. Through this, the information processing apparatus 101 can discover each device that sent a response through the communication app, and can execute processing based on the result of the multicast search.

Incidentally, although the communication app is responsible for specifying the content of broadcast search packets and multicast search packets, it is the OS operating at the lowest layer in the information processing apparatus 101 that is responsible for sending those packets. Accordingly, in environments where Android OS apps operate in the second environment, it is necessary for Chrome OS to perform the broadcast searches and multicast searches. However, when an Android OS app operates in the second environment, the Chrome OS may use its own firewall to perform control such that broadcast searches and multicast searches in which the Android OS app is the source of the instructions and the socket API is used are not performed. As a result, there is a problem in that if the communication app is operating in the second environment, the communication app may not be able to perform processing based on the result of a broadcast search or a multicast search. Note that the Chrome OS firewall does not block broadcast searches and multicast searches in which a Chrome OS app is the source of the instructions. Accordingly, if the information processing apparatus 101 operates a Chrome OS app on the Chrome OS, and the socket API instructs a broadcast search or multicast search to be performed from that app, the Chrome OS can perform the broadcast search or multicast search.

Additionally, in the present embodiment, the communication app supports searching for devices through WFD. As such, if the information processing apparatus 101 on which the communication app is operating supports WFD, the communication app can perform processing based on the result of a search by instructing the OS of the information processing apparatus 101 to search for devices through WFD and receiving the result of the search.

However, devices provided with the Chrome OS, and the Chrome OS itself, do not support WFD, and it is often not possible to search for devices through WFD. There is thus a problem in that if the communication app is operating in the second environment, the communication app may not be able to perform processing based on the result of a device search performed through WFD.

### Configuration of Communication Application (Communication App)

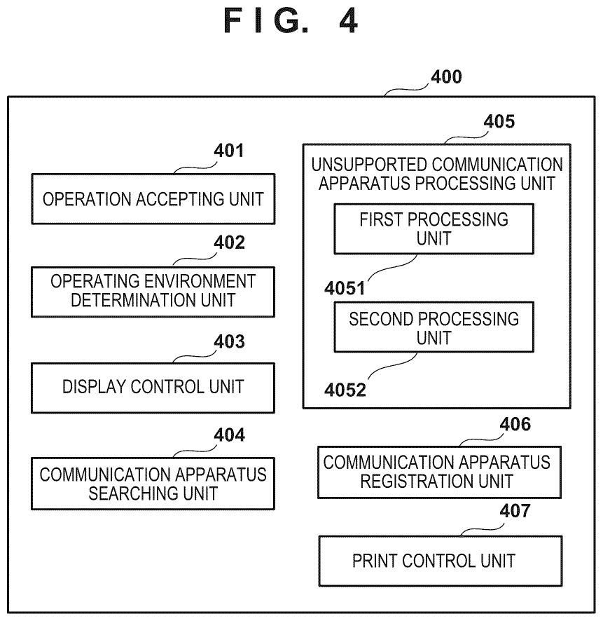

FIG. 4 illustrates the configuration of a communication application stored in the ROM 104, the external storage device 106, or the like of the information processing apparatus 101. The communication application is an application program having a printing function that causes the communication apparatus 151, which functions as a printer or a printing apparatus, to print image data, document data, or the like held in the information processing apparatus 101. The communication application also has a function for importing image data, document data, and the like scanned by the communication apparatus 151 into the information processing apparatus 101.

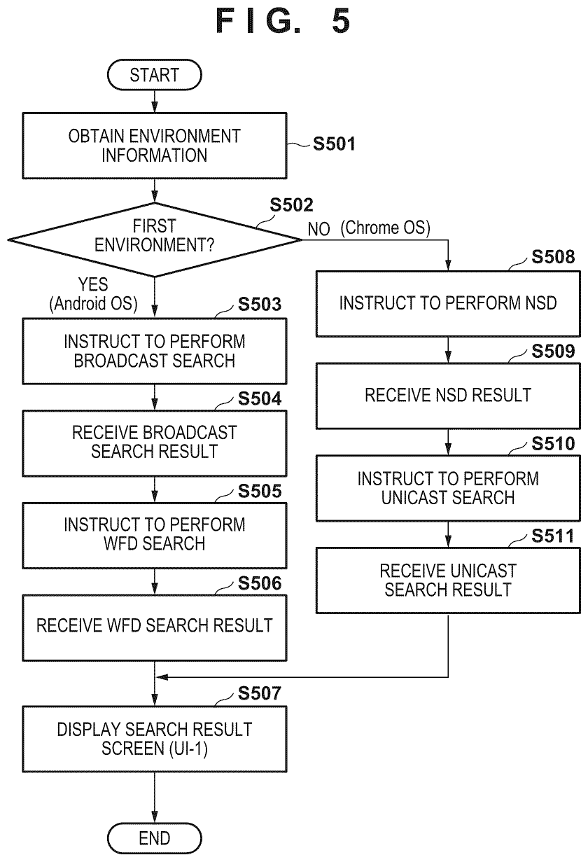

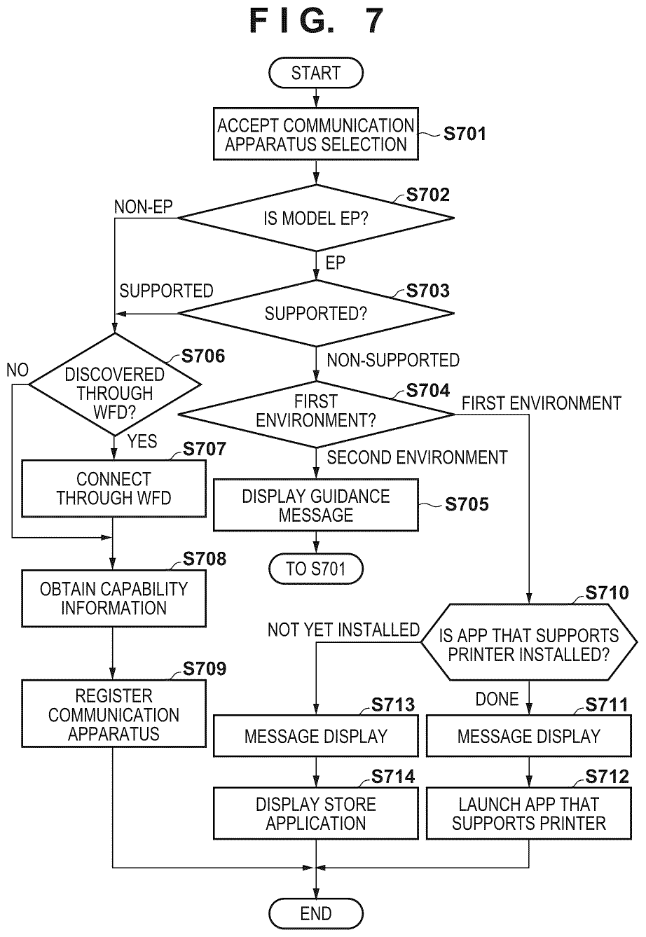

A communication app 400 includes an operation accepting unit 401, an operating environment determination unit 402, a display control unit 403, a communication apparatus searching unit 404, an unsupported communication apparatus processing unit 405, a communication apparatus registration unit 406, and a print control unit 407. Each program module is executed by the CPU 103 to realize the corresponding function. In the present embodiment, the communication app 400 uses the operation accepting unit 401 to accept operations made through the console unit 108. The operating environment determination unit 402 determines whether the current operating environment of the communication app 400 is the first environment provided by the Android OS, or the second environment provided by the virtual Android OS built on the Chrome OS. This determination can be made based on a response obtained by querying the OS, or by referring to a predetermined storage location. The operating environment determination unit 402 makes the determinations in step S501 of FIG. 5 and step S704 of FIG. 7 (described later), for example.

The display control unit 403 controls displays made in the console unit 108 by the communication app 400. In particular, a list of printers searched for (i.e., the communication apparatus 151) is displayed in the console unit 108 of the information processing apparatus 101. When the processing performed by the unsupported communication apparatus processing unit 405 (described later) involves a display, that display is controlled as well.

The communication apparatus searching unit 404 can connect to the information processing apparatus 101 through a sequence such as that described later with reference to FIG. 5, and searches for a printer (the communication apparatus 151) that can be used by the communication app 400. The communication apparatus searching unit 404 functions as the information processing apparatus 101 in the sequence illustrated in FIG. 2, for example, and searches for the communication apparatus 151.

The unsupported communication apparatus processing unit 405 executes processing when the communication app 400 does not support the communication apparatus 151 selected by the user from among the printers discovered through the search. This processing differs between the first environment and the second environment, and the processing in those execution environments is performed by a first processing unit 4051 and a second processing unit 4052, respectively. As the specific processing, for example, the first processing unit 4051 performs processing for prompting the user to launch or install another app that supports the selected printer. On the other hand, the second processing unit 4052 displays a message guiding the user to print using the selected printer. The unsupported communication apparatus processing unit 405 performs the processing of steps S704 to S714 of FIG. 7 (described later), for example. In particular, the first processing unit 4051 handles the processing of steps S710 to S714 in FIG. 7, and the second processing unit 4052 handles the processing of step S705 of FIG. 7.

The communication apparatus registration unit 406 registers the communication apparatus 151 selected from among the printers discovered through the search as the printer to be used by the communication app 400. The registered printer can be used thereafter without performing a search. The communication apparatus registration unit 406 performs the processing of steps S706 to S709 of FIG. 7 (described later), for example.

The print control unit 407 sends the selected data to be printed to the selected communication apparatus 151 to print the data. The data to be printed may be, for example, document data, image data, or the like stored when the communication app 400 is launched. Alternatively, the data may be data obtained from a cloud server, the communication apparatus 151, or the like. The data may also be obtained from another data source. In the following, the processing illustrated as processing performed by the configurations illustrated in FIGS. 3A and 3B, which are configurations within the communication app, is assumed to be processing implemented by the CPU 103 reading out the communication app stored in the ROM 104 or the like into the RAM 105 and executing the communication app. For printing, the print control unit 407 generates a print job and sends the print job to the communication apparatus 151 (i.e., the printer). The communication apparatus 151 executes the received print job and prints the data.

### Device Search by Communication App

FIG. 5 is a flowchart illustrating a device search performed by the communication app according to the present embodiment. This flowchart is realized by the CPU 103 loading various programs stored in a memory, such as the external storage device 106, into the RAM 105 and executing those programs. Specifically, this flowchart is realized by the communication app 400 being executed. This corresponds to processing performed by the communication apparatus searching unit 404 in particular. Additionally, this processing is assumed to be started when an operation triggering a device search is performed by the user in a screen displayed by the communication app. However, the configuration is not limited thereto, and the processing be started in response to the communication app being launched, for example.

In step S501, the CPU 103 obtains environment information regarding the environment in which the communication app is operating by executing an API of the Android OS from the communication app. If the environment in which the communication app is operating is the first environment, information corresponding to the first environment is obtained as the environment information. On the other hand, if the environment in which the communication app is operating is the second environment and the API executed is a virtual Android OS API, information corresponding to the second environment is obtained as the environment information.

In step S502, the CPU 103 determines whether the environment in which the communication app is operating is the first environment based on the environment information obtained in step S501. If the result of the determination is “yes”, the CPU 103 moves the sequence to step S503, whereas if the result of the determination is “no”, the CPU 103 moves the sequence to step S508.

In step S503, the CPU 103 determines the content of the broadcast search packet through the communication app. The CPU 103 then instructs the Android OS to send the packet of the determined content through the communication app by executing the socket API from the communication app. In other words, the CPU 103 executes the processing for a broadcast search through the communication app. Through this, the CPU 103 sends the broadcast search packet from the Android OS to the access point 131. The present embodiment assumes that the broadcast search packet is configured such that only a device supported by the communication app can respond to the packet. The present embodiment also assumes that a plurality of types of broadcast search packets are broadcast. Specifically, the plurality of types of broadcast search packets include a type of packet configured such that only ink jet printers can respond thereto, and a type of packet configured such that only electrophotographic printers can respond thereto. Note that the packets may include a type of packet configured such that only old models of ink jet printers can respond thereto, and a type of packet configured such that only new models of ink jet printers can respond thereto. Specifically, for example, the CPU 103 varies the devices to be searched for by varying a port number set in the broadcast search packet. This makes it possible to discover only the desired device in the broadcast search. The type of device discovered through the broadcast search can then be determined (i.e., whether the device is an ink jet printer or an electrophotographic printer, or the like).

In step S504, the CPU 103 obtains a response to the broadcast search packet from the Android OS through the communication app. Through this, the device that is the source of the response is identified as the device discovered through the broadcast. The response includes whether the query was successful, the type of the device (printer or the like), and a model name. The response may also include the IP address, mac_address, or the like of the communication apparatus.

Although the foregoing describes the processing for the broadcast search as being performed in steps S503 and S504, the configuration may be such that the processing for a multicast search is performed. In other words, in step S503, the CPU 103 may determine the content of the multicast search packet through the communication app, and instruct the Android OS to send a packet having the determined content through the communication app by executing the socket API from the communication app. Then, in step S504, the CPU 103 may obtain a response to the multicast search packet from the Android OS through the communication app.

In step S505, the CPU 103 instructs the Android OS to execute a search through WFD (i.e., send device search information through WFD) through the communication app by executing an API for WFD. Through this, the CPU 103 sends the device search information from the Android OS. The Android OS then receives a device search response from a WFD-compatible device in the vicinity of the information processing apparatus 101. This processing corresponds to the processing of steps S201 and S202 of FIG. 2.

In step S506, the CPU 103 obtains the device search response from the Android OS through the communication app. Through this, the device that is the source of the device search response is identified as the device discovered through the search using WFD. Note that at this time, of the devices from which the device search responses are sent, only devices supporting the printing service may be identified as devices discovered through the search using WFD. Which device corresponds to which service can be confirmed through communication between the device from which the device search response was sent and the information processing apparatus 101.

In step S507, which is executed after step S506, the CPU 103 displays, through the communication app, a search result screen, which is a screen indicating the list of one or more devices discovered through the broadcast search and one or more devices discovered through the WFD search. The devices are based on the information obtained in steps S504 and S506. Alternatively, if the sequence has branched from step S502 to step S508, the communication app displays the apparatuses based on the information obtained in steps S509 and S511 (described later). Note that in the search result screen, the stated list may be displayed such that the one or more devices discovered through the broadcast search can be distinguished from the one or more devices discovered through the WFD search. Specifically, for example, in the search result screen, an icon corresponding to a device discovered through the broadcast search may be added to a display item corresponding to the device discovered through the broadcast search. Likewise, in the search result screen, an icon corresponding to a device discovered through WFD may be added to a display item corresponding to the device discovered through WFD. Additionally, in the search result screen, the stated list may be displayed such that ink jet printers and electrophotographic printers can be distinguished from each other. The CPU 103 then accepts the selection of one of the devices displayed in the search result screen from the user through the communication app.

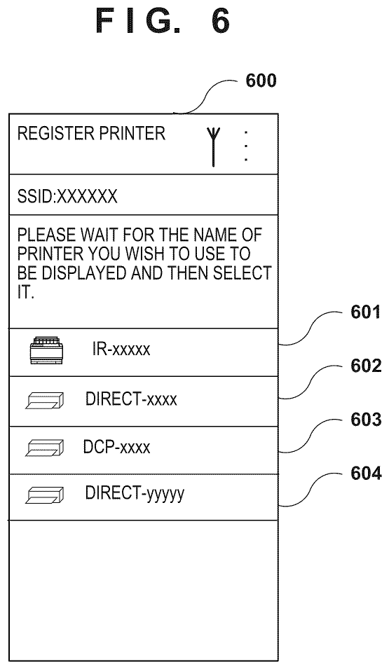

FIG. 6 is a diagram illustrating an example of the display performed in step S507. A screen 600 is displayed in the console unit 108 of the information processing apparatus 101. Note that FIG. 6 illustrates an example of a case where the search processing illustrated in FIG. 5 has been performed to register a printer, and “printer registration” is displayed as the title. Furthermore, in the screen 600, a list of printers (communication apparatuses) discovered through the search is displayed, and items 601 to 604 correspond to the respective printers. Here, as described above, ink jet printers and electrophotographic printers are displayed with different icons so as to be distinguishable from each other. Note that this distinction may be made based on, for example, model names received as search responses. The user can select a printer through an operation such as tapping the field where the desired printer is displayed in the printer list.

On the other hand, if the result of the determination made in step S502 is “no”, i.e., if the current operating environment is the second environment, the sequence branches to step S508. In step S508, through the communication app, the CPU 103 performs processing for searching for devices on the network to which the information processing apparatus 101 belongs using an API different from the socket API. Specifically, the API used here is a network service discovery (NSD) API. By executing this API from the communication application, a search called “NSD” is executed. NSD is a multicast search performed using the DNS-based service discovery protocol. NSD is also a search that can be executed in response to an instruction from the communication app even in the second environment. Specifically, in this processing, when the API is executed from the communication app, the virtual Android OS instructs the Chrome OS to execute NSD. Then, when the Chrome OS executes NSD, a device which is a device on the network to which the information processing apparatus 101 belongs and which is compliant with NSD is discovered. It should be noted that in executing the NSD API, the communication app can specify devices corresponding to a certain service to be searched for through NSD. The service is specified by specifying the protocol, for example. Accordingly, in the present embodiment, the communication app specifies a device corresponding to the printing service (i.e., a printer) to be searched for by specifying the Internet Printing Protocol (IPP). Although the communication app specifies an IP address to specify the device to which the packet is sent when instructing a search using the socket API, the communication app does not specify the IP address when instructing a search using the NSD API.

Next, in step S509, the CPU 103 obtains, through the communication app, information pertaining to the discovered device as a result of the search performed through NSD. Specifically, the information obtained here is, for example, the IP address, port number, service name, or the like of the discovered device.

Next, in step S510, the CPU 103 executes processing for performing a unicast search for one or more devices discovered through NSD. Although the present embodiment assumes that the processing for executing the unicast search is executed for all the devices discovered through NSD, the configuration is not limited thereto. The processing for executing the unicast search may be executed for some of the devices discovered through NSD. “Unicast search” is a method for searching the network to which the information processing apparatus 101 belongs having specified the device to be search for by IP address. The IP address the device discovered through NSD is obtained by the communication app as the result of the NSD search, and thus a device discovered through NSD can be searched for again through a unicast search. Note that the scope of a broadcast search is limited to a subnetwork to which the information processing apparatus 101 belongs. On the other hand, the scope of the unicast search includes both the subnetwork to which the information processing apparatus 101 belongs, as well as other subnetworks connected to the stated subnetwork. A “subnetwork” is a unit corresponding to a single network formed by a single access point. The unicast search is also a search that can be executed in response to an instruction from the communication app even in the second environment.

Specifically, and this processing, the CPU 103 determines the content of the unicast search packet through the communication app. Then, by executing the socket API, the CPU 103 instructs the virtual Android OS to send the packet of the determined content through the communication app. Note that the unicast search packet is a packet in which a unicast search value is set in the IP address storage region, and a value corresponding to a designation of the destination of the packet (i.e., the address of the device to search for) is set. The present embodiment assumes that the unicast search packet is configured such that only a device supported by the communication app can respond to the packet. The present embodiment also assumes that a plurality of types of unicast search packets are sent to a single device. Specifically, “a plurality of types of unicast search packets” include a type of packet configured such that only ink jet printers can respond thereto, and the type of packet configured such that only electrophotographic printers can respond thereto. Note that the packets may include a type of packet configured such that only old models of ink jet printers can respond thereto, and a type of packet configured such that only new models of ink jet printers can respond thereto.

This makes it possible to discover only the desired device in the unicast search. The type of device discovered through the unicast search can then be determined (i.e., whether the device is an ink jet printer or an electrophotographic printer, or the like). In the present embodiment, the content of the unicast search packet is assumed to differ from the content of the broadcast search packet only in terms of the IP address indicating the destination of the packet. Then, the virtual Android OS instructs the Chrome OS to perform the unicast search. The Chrome OS then performs the unicast search by sending the unicast search packet. Through this, a response is received from a device that is on the network to which the information processing apparatus 101 belongs and that corresponds to the IP address specified in the unicast search packet, and that device is discovered as a result.

Next, in step S511, the CPU 103 obtains information on the discovered device through the communication app as the result of the unicast search. Specifically, the information obtained here is, for example, the IP address, MAC address, model name, serial number, and the like of the discovered device. Executing the unicast search after NSD makes it possible to identify a device, among the devices discovered through NSD, that supports the communication app. It is also possible to obtain information that could not be obtained through NSD. The sequence then branches to step S507, where the CPU 103 displays a list of the discovered devices. In step S507 executed after step S511, the CPU 103 displays, through the communication app, the search result screen, which is a screen indicating a list of the devices discovered to the unicast search. Note that in the search result screen, the stated list may be displayed such that ink jet printers and electrophotographic printers can be distinguished from each other. The CPU 103 then accepts the selection of one of the devices displayed in the search result screen from the user through the communication app.

In this manner, whether a broadcast search is performed is switched based on the environment in which the communication app operates, through the sequence illustrated in FIG. 5. Specifically, a broadcast search is performed when the environment in which the communication app operates is the first environment, whereas other processing is performed, without performing a broadcast search, when the environment in which the communication apparatus operates is the second environment. Specifically, the “other processing” is, for example, a search through NSD, a unicast search, or the like. This makes it possible for the communication app to perform appropriate processing based on the environment in which the communication app operates.

Note that the communication app determines whether to instruct a broadcast search, a multicast search, or unicast search according to the IP address specified when the socket API is executed. In other words, which search is to be instructed is determined by specifying an address corresponding to one of these types of content as the IP address included in the packet sent for the search. In other words, the present embodiment is an embodiment in which the content of the IP address specified in the packet used for the search is switched based on the environment in which the communication app operates.

Note that the processing performed when the environment in which the communication app operates is the second environment is not limited to the processing described above. For example, this processing may be processing for displaying a notification screen which notifies the user that a broadcast search cannot be performed. In a situation where the notification screen is not displayed, an NSD search, a unicast search, and the like need not be performed. Additionally, the notification screen may be a screen for notifying the user that the environment in which the communication apparatus is the second environment, a screen for notifying the user that the communication apparatus cannot be registered in the communication app, or the like. Furthermore, the notification screen may be a screen for prompting the user to operate the communication app in the first environment.

Additionally, the search method is not limited to the method described above. For example, the order in which the processing for searching through broadcast (steps S503 and S504) and the processing for searching through WFD (steps S505 and S506) are performed may be reversed, or those searches may be performed at the same time. Additionally, rather than displaying the search result screen after each search ends, each time a device is discovered through one of the searches, the discovered device may be added to the search result screen.

Additionally, the communication app may be capable of accepting an operation for instructing a broadcast search to be performed and an operation for instructing a WFD search to be performed from the user individually. Then, when an operation instructing a broadcast search to be performed is made, the flowchart of FIG. 5 may be executed without executing the processing for a WFD search. Similarly, when an operation instructing a WFD search to be performed is made, the flowchart of FIG. 5 may be executed without executing the processing for a broadcast search. The communication app may be an app that supports only broadcast searches or WFD searches. In other words, when the communication app is an app that only supports broadcast searches, the flowchart of FIG. 5 may be executed without executing the processing for a WFD search. Likewise, when the communication app is an app that only supports WFD searches, the flowchart of FIG. 5 may be executed without executing the processing for a broadcast search.

Although the foregoing described a configuration in which the processing for a unicast search (steps S510 and S511) is executed after the processing for NSD (steps S508 and S509), the configuration is not limited thereto. For example, the configuration may be such that the processing for a unicast search is not performed in the flowchart of FIG. 5, and devices discovered through NSD are displayed in the search result screen. Here, the configuration may be such that a device that is supported by the communication app stores information indicating that the device is supported by the communication app as a response to the NSD. Through this, only devices, among the devices discovered through NSD, which have been identified as devices supported by the communication app may be displayed in the search result screen.

### Printer (Communication Apparatus) Registration Processing

FIG. 7 illustrates an example of processing for registering a printer selected from one or more printers displayed in the screen illustrated in FIG. 6. As described earlier, a registered printer can be used for printing without needing to search for the registered printer each time the printer is to be used. However, this is of course conditional on the information processing apparatus 101 being able to connect to the printer, which is the communication apparatus 151, and thus if such a connection cannot be made, a new printer is searched for or an attempt is made to use another registered printer.

In FIG. 7, the CPU 103 accepts the selection of a printer in the screen illustrated in FIG. 6 (step S701). The CPU 103 then determines whether the model of the selected printer is a model that prints through the electrophotographic method, i.e., is an EP device (step S702). An “EP device” is, in other words, an electrophotographic printer. For example, a printer which is a model that prints through the ink jet (IJ) method is determined not to be an EP device. A printer which is a model that prints through the ink jet (IJ) method is, in other words, an IJ device, and is an ink jet printer. This determination may be made based on information indicating the model, such as the model name included in the responses received from printers as a result of the search. In this case, the communication app 400 may hold information indicating model names and whether those models are EP devices, and may make the determination by referring to that information.

If it is determined in step S702 that the model of the selected printer is a model that prints using the electrophotographic method, the CPU 103 determines whether the communication app 400 supports the printer selected in step $702. In the present embodiment, the printers supported by the communication app 400 are assumed to be all models of printers, provided by the vendor who provides the communication app 400, that print using the ink jet method, and some models of printers, provided by the vendor who provides the communication app 400, that print using the electrophotographic method. However, the configuration is not limited thereto, and the printers supported by the communication app 400 may be some models of printers, provided by the vendor who provides the communication app 400, that print using the ink jet method. In this case, the determination of step S702 may be skipped, with the sequence moving to step S703 after step S701. Note that the communication app 400 may hold information, such as model names or the like, of printers supported by the communication app 400 in advance, and may make this determination based on that information.

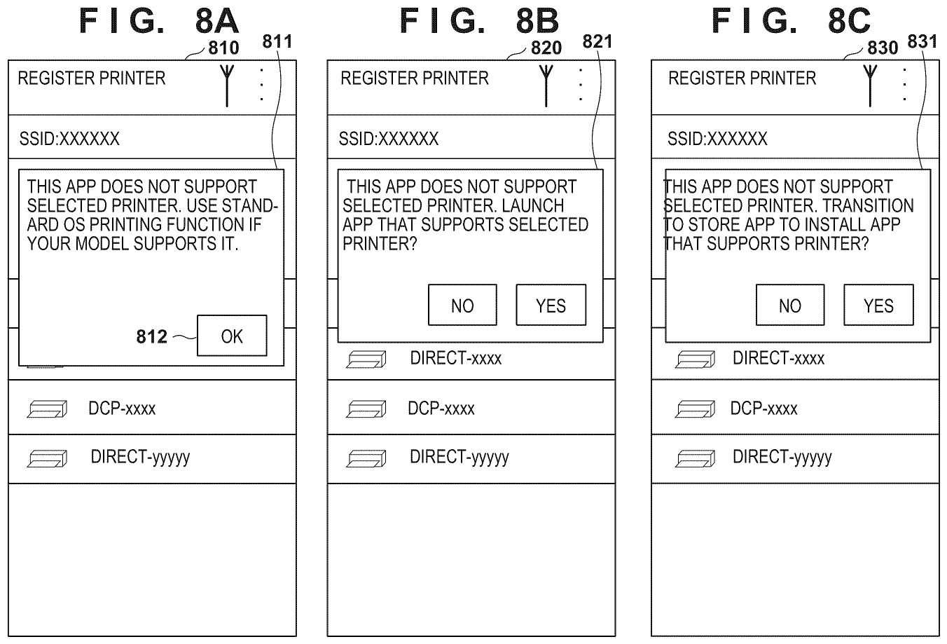

If the selected printer is determined in step S703 to be a model not supported by the communication app 400, the CPU 103 determines whether the current execution environment of the communication app 400 is the first environment or the second environment (step S704). If the current execution environment is the second environment, i.e., is an environment in which a virtual Android OS is being operated on the Chrome OS, the CPU 103 displays a message to the user without registering the selected printer (step S705). FIG. 8A illustrates an example of this display. A message 811 guiding the user is displayed in a window 810. Even if the current execution environment of the communication app 400 is the second environment and the selected printer is a model not supported by the communication app 400, it may be possible to send a print job to the selected printer if the printing function is a function provided by the Chrome OS (a standard printing function of the Chrome OS). Accordingly, the message 811 informs the user that the communication app 400 does not support the selected printer (i.e., that the selected printer is not supported by the communication app 400). The message 811 also informs the user that it may be possible to print using the printing function provided by the Chrome OS. In other words, the user is prompted to use the printing function provided by the Chrome OS.

Note that the printing function provided by the Chrome OS is implemented by a printing application program standard to the host OS (here, the Chrome OS). As such, the message 811 may, in other words, be a message pertaining to a printing application program standard to the host OS, and may be a message prompting the user to use that program. The message 811 may include a message indicating an operation method for using the printing application program standard to the host OS. Like the host OS, the printing application program standard to the host OS is a program pre-installed in the information processing apparatus 101 from the time when the information processing apparatus 101 arrives. In other words, the printing application program standard to the host OS is an app that is not installed by a store app, which is an app for installing various types of apps in the information processing apparatus 101 from the Internet.

The printing function provided by the Chrome OS is a printing function implemented using the Internet Printing Protocol (IPP). Specifically, for example, in the printing function provided by the Chrome OS, searches for printers to which print jobs are to be sent, the sending of print jobs, and the like are executed using IPP. Accordingly, the printing application program standard to the host OS is a program that executes the processing described above using IPP. As such, the user can be guided to use the printing application program standard to the host OS, which is different from the predetermined program, i.e., the communication app, and which is also different from another program launched in step S712 (described later).

As described above, this printing application program can send print jobs to the selected printer. Accordingly, the communication app 400 can guide the user for the user's purpose, i.e., in a direction in which it can be expected that printing can be performed reliably, without launching another app. Not launching another app makes it possible to suppress a drop in the usability, by preventing the occurrence of further problems and clearly indicating responses that the user can take. When the user selects an OK button 812 displayed in the message 811, the CPU 103 may hide the message and return to the screen 600 illustrated in FIG. 6. In this state, the system waits for the selection of a printer to be registered. Once a printer is selected, the sequence is repeated from step S701.

Note that the processing performed in S705 is not limited to the processing for displaying the message 811. For example, the processing executed in step S705 may be processing of executing the printing function provided by the Chrome OS. Specifically, for example, the processing performed in step S705 may be processing of launching the printing application program standard to the host OS. The processing performed in step S705 may also include processing of querying the user as to whether to execute the printing function provided by the Chrome OS, and the printing function may be executed when an input for executing the printing function is received.

If the model of the printer selected in step S702 is determined not to be an EP device, or is determined in step S703 to be a supported model, the CPU 103 determines that the printer has been discovered through WFD (step S706). Being discovered through WFD corresponds to being discovered in steps S505 and S506 in FIG. 5. In this case, the CPU 103 connects to the selected printer through WFD (step S707). In the present embodiment, if the selected printer is not an EP device, that printer is determined to be supported by the communication app 400. However, even if the selected printer is not an EP device, it may be determined whether that printer is supported, in the same manner as in step S703. In this case, if the model is not supported, an indication to that effect is displayed, in the sequence returns to step S701.

If it is determined after step S707, or in step S706, that the printer was not discovered through WFD, the CPU 103 obtains capability information from the selected printer (step S708). After the capability information is obtained, the CPU 103 registers the selected printer (communication apparatus) (step S709). The information registered may be, for example, a name, a connection destination address, the obtained capability information, or the like.

If the current execution environment is determined to be the first environment in step S704, the CPU 103 determines whether an app (program) that supports the selected printer but that is not the communication app 400 is already installed (step S710). In the present embodiment, the Android apps executed in the first environment include another app that supports electrophotographic printers that are not supported by the communication app 400. This other app can use functions such as printing, scanning, and the like provided by a large-size electrophotographic printer used for business purposes, called a “multifunction peripheral”. Accordingly, the communication app 400 determines whether another app which supports the selected printer not supported by the communication app 400 itself is already installed.

If the stated other app is already installed, the CPU 103 displays a message to that effect (step S711). FIG. 8B illustrates an example of this message 821. The message 821 includes an indication that the communication app 400 currently operating does not support the selected printer, and a button for accepting a selection as to whether to launch the other app that supports the selected printer. If the user selects “yes”, i.e., makes a selection to launch the other app (i.e., the other program), the CPU 103 launches that app (step S712). An operation screen of the launched app is then displayed, and the user may therefore operate that screen to print an image or the like to be printed. Note that in the present embodiment, the sequence may be ended without the communication app 400 registering the selected printer. A window 820 of the communication app 400 after the other app is launched may be left as-is until the other app is terminated, or may return to a home screen of the communication app 400.

On the other hand, if an app that supports the selected printer is determined not to be installed in step S710, the CPU 103 displays a message to that effect (step S713). FIG. 8C illustrates an example of this message 831. The message 831 includes an indication that the communication app 400 currently operating does not support the selected printer, and a button for accepting a selection as to whether to install the other app that supports the selected printer. To install the app, it is necessary to download the app from a store app that provides the app. A confirmation for switching to the store app is therefore also included in the message. “Switching to the store app” refers to the communication app 400 connecting to a store app known in advance and displaying a screen thereof.

If the user selects “yes”, i.e., makes a selection to install the other app, the CPU 103 transitions to the store app for that app (step S714). The user then performs an operation for downloading the stated app from the store app and installing the app. After the installation, the CPU 103 may launch the installed app immediately. In this case, an operation screen of the launched app is then displayed, and the user may therefore operate that screen to print an image or the like to be printed. Note that in the present embodiment, the sequence may be ended without the communication app 400 registering the selected printer. A window 830 of the communication app 400 after the other app is launched may be left as-is until the other app is terminated, or may return to a home screen of the communication app 400.

According to the present embodiment as described above, when, in the second environment, the communication app does not support the selected printer, guidance is provided indicating that the communication app does not support the selected printer. Additionally, the user is informed that it may be possible to print using a printing function provided by the host OS, and is guided to use that function. The communication app can therefore guide the user to the function for printing using the host OS without launching another app. As a result, the communication app does not launch another app, which makes it possible to prevent further problems from occurring. A drop in the usability can also be suppressed by clearly indicating responses that the user can take.

Furthermore, printers can be searched for using a method (or protocol) corresponding to the operating environment, namely the first environment and the second environment. This makes it possible to search for printers that can connect to the information processing apparatus operating the communication app regardless of the operating environment of the communication app.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-173861, filed Oct. 5, 2023 which is hereby incorporated by reference herein in its entirety.

What is claimed is:

1. A non-transitory computer-readable medium having stored a predetermined program operatable on an operating system (OS), which when executed by one or more processors of a first information processing apparatus having a first operating environment on a first OS operating as a host OS but not on a guest OS, cause the first information processing apparatus to perform a first method, the first method comprising:
displaying one or more printers discovered through a search performed by the first information processing apparatus;
accepting a selection of any printer among the one or more printers; and
when the printer selected from the one or more printers is a printer not supported by the predetermined program, performing processing related to an other program different from the predetermined program, and
wherein the predetermined program, which when executed by one or more processors of a second information processing apparatus having a second operating environment on a second OS operating as the host OS and on the guest OS, cause the second information processing apparatus to perform a second method, the second method comprising:
displaying one or more printers discovered through a search performed by the second information processing apparatus;
accepting a selection of any printer among the one or more printers; and
when the printer selected from the one or more printers is a printer not supported by the predetermined program, performing processing related to a printing program standard in the host OS, the printing program being different from the predetermined program and the other program.

2. The computer-readable medium according to claim 1,
wherein processing for launching the other program is performed as the processing related to the other program.

3. The computer-readable medium according to claim 1,
wherein processing for launching a store app for installing the other program is performed as the processing related to the other program in a case where the other program is not installed in the first information processing apparatus.

4. The computer-readable medium according to claim 1,
wherein the other program is a program capable of sending a print job to a printer not supported by the predetermined program.

5. The computer-readable medium according to claim 1,
wherein the other program is a program provided by a vendor that provides the predetermined program.

6. The computer-readable medium according to claim 1,
wherein processing for notifying a user to use the printing program standard in the host OS is performed as the processing related to the printing program standard in the host OS.

7. The computer-readable medium according to claim 1,
wherein when the printer selected from the one or more printers is a printer supported by the predetermined program, the predetermined program causes each of the first information processing apparatus and the second information processing apparatus to perform processing for registering the printer supported by the predetermined program in the predetermined program.

8. The computer-readable medium according to claim 1,
wherein the printer supported by the predetermined program is an ink jet printer.

9. The computer-readable medium according to claim 1,
wherein the printer supported by the predetermined program is one of models of an electrophotographic printer.

10. The computer-readable medium according to claim 1,
wherein the search performed by the first information processing apparatus and the search performed by the second information processing apparatus are different.

11. The computer-readable medium according to claim 1,
wherein the search performed by the first information processing apparatus includes a search through a broadcast performed using a socket application programming interface (API).

12. The computer-readable medium according to claim 1,
wherein the search performed by the first information processing apparatus includes a search performed using Wi-Fi Direct.

13. The computer-readable medium according to claim 1,
wherein the search performed by the second information processing apparatus includes a search through a multicast performed using a network service discovery (NSD) protocol.

14. The computer-readable medium according to claim 1,
wherein the search performed by the second information processing apparatus includes a search through a unicast performed using a socket API.

15. The computer-readable medium according to claim 1,
wherein the one or more printers are displayed to be distinguishable as ink jet printers or electrophotographic printers.

16. The computer-readable medium according to claim 1,
wherein the host OS of the first operating environment is an Android OS, the host OS of the second operating environment is a Chrome OS, and the guest OS of the second operating environment is a virtual Android OS.

17. The computer-readable medium according to claim 1,
wherein the first method and the second method further comprises determining whether an environment in which the predetermined program is operating is the first operating environment, and
when the printer selected from the one or more printers is a printer not supported by the predetermined program, whether to execute the processing related to the other program or execute the processing related to the printing program standard in the host OS is controlled based on a result of the determination.

18. The computer-readable medium according to claim 1,
the first method and the second method further comprises transmitting a print job for causing the printer selected from the one or more printers to print when the printer selected from the one or more printers is a printer supported by the predetermined program.

19. The computer-readable medium according to claim 1,
wherein the predetermined program is an application program.

20. A method of controlling a first information processing apparatus having a predetermined program operatable on an operating system (OS) and having a first operating environment on a first OS operating as a host OS but not on a guest OS, and a second information processing apparatus having the predetermined program and having a second operating environment on a second OS operating as the host OS and on the guest OS, the method comprising:
displaying, by the predetermined program in the first information processing apparatus, one or more printers discovered through a search performed by the first information processing apparatus;
accepting, by the predetermined program in the first information processing apparatus, a selection of any printer among the one or more printers;
when the printer selected from the one or more printers is a printer not supported by the predetermined program, performing, by the predetermined program in the first information processing apparatus, processing related to an other program different from the predetermined program;
displaying, by the predetermined program in the second information processing apparatus, one or more printers discovered through a search performed by the second information processing apparatus;
accepting, by the predetermined program in the second information processing apparatus, a selection of any printer among the one or more printers; and
when the printer selected from the one or more printers is a printer not supported by the predetermined program, performing, by the predetermined program in the second information processing apparatus, processing related to a printing program standard in the host OS, the printing program being different from the predetermined program and the other program.
